(19) United States
(12) Patent Application Publication
(10) Pub. No.: US 2022/0407872 A1
(43) Pub. Date: Dec. 22, 2022

(54) METHOD AND DEVICE FOR COUNTERACTING INTRUSION INTO IN-VEHICLE NETWORK

(71) Applicants: HYUNDAI MOTOR COMPANY, Seoul (KR); KIA CORPORATION, Seoul (KR)

(72) Inventors: Young Bin Min, Gwangmyeong-si (KR); Seung Wook Park, Yongin-si (KR)

(73) Assignees: HYUNDAI MOTOR COMPANY, Seoul (KR); KIA CORPORATION, Seoul (KR)

(21) Appl. No.: 17/512,052

(22) Filed: Oct. 27, 2021

(30) Foreign Application Priority Data
Jun. 22, 2021 (KR) 10-2021-0080835

(51) Int. Cl. H04L 29/06; B60R 16/023; H04L 12/40; H04L 29/08; F02D 41/22

(52) U.S. Cl. CPC H04L 63/1416; H04L 63/145; B60R 16/0234; H04L 12/40; H04L 67/12; F02D 41/22; H04L 2012/40215

(57) ABSTRACT

A method and a device for counteracting an intrusion into an in-vehicle network are disclosed. The present disclosure in some aspects provides a device and a control method for counteracting an intrusion into an in-vehicle network of a vehicle, including a communication unit configured to communicate with an external network and the in-vehicle network, a memory storing instructions, and at least one processor, wherein the instructions stored in the memory cause, when executed, the at least one processor to perform monitoring an intrusion attempt from the external network into the in-vehicle network, blocking communication between the communication unit and the external network upon detecting the intrusion into the in-vehicle network, establishing a communication link with a terminal of a driver of the vehicle through the communication unit, and performing communication with the external network through the communication unit and the terminal of the driver.

### CROSS-REFERENCE TO RELATED APPLICATIONS

This application is based on and claims the benefit of priority to Korean Patent Application Number 10-2021-0080835, filed on Jun. 22, 2021 in the Korean Intellectual Property Office, the disclosure of which is incorporated by reference herein in its entirety.

### TECHNICAL FIELD

The present disclosure in some embodiments relates to a technology of detecting and counteracting an intrusion into an in-vehicle network (IVN).

### BACKGROUND

The statements in this section merely provide background information related to the present disclosure and do not necessarily constitute prior art.

An autonomous vehicle refers to a vehicle capable of operating by itself without the manipulation of a driver or a passenger. An autonomous driving system refers to a system that monitors and controls such the autonomous vehicle to operate by itself.

Autonomous vehicles exchange driving-related information with each other while driving and communicates with the external network of the vehicles for safety. Autonomous vehicles are aware of their surroundings through communication with the external network thereof. By linking the external network with an in-vehicle network (IVN) which is composed of various electronic devices in the autonomous vehicle, the vehicle can provide improved services using information that combines the internal state of the vehicle and external information. This service offering increasingly relies on electronic control units (ECUs) installed on a vehicle.

However, with vehicles linked to the wireless communication and surrounding network environment, they have become vulnerable to attacks that violate their ECUs from the outside through the network. The consequences of the external attack may be fatal vehicle malfunctions to the vehicle and its occupants.

An intrusion detection system (IDS) or an intrusion detection and prevention system (IDPS) is being introduced to detect and counteract a security threat of an external network to a vehicle.

However, even with the ability to detect an intrusion into the vehicle from its external network, a practical security method for counteracting the intrusion is not yet provided.

### SUMMARY

According to at least one aspect, the present disclosure provides a method performed by an onboard device in a vehicle for counteracting an intrusion into an in-vehicle network to protect the in-vehicle network, the method including monitoring an intrusion attempt from an external network into the in-vehicle network, blocking a communication with the external network upon detecting the intrusion into the in-vehicle network, establishing a communication link with a terminal of a driver of the vehicle, and performing a communication with the external network through the terminal of the driver.

According to another aspect, the present disclosure provides a device for counteracting an intrusion into an in-vehicle network of a vehicle, including a communication unit configured to communicate with an external network that is outside of the vehicle and the in-vehicle network, a memory in which instructions are stored, and at least one processor. Here, the instructions stored in the memory cause, when executed, the at least one processor to perform steps including monitoring an intrusion attempt from the external network into the in-vehicle network, blocking a communication between the communication unit and the external network upon detecting the intrusion into the in-vehicle network, establishing a communication link with a terminal of a driver of the vehicle through the communication unit, and performing a communication unit and the terminal of the driver.

### BRIEF DESCRIPTION OF THE DRAWINGS

FIG. 1 is a schematic diagram illustrating a vehicle network system according to at least one exemplary embodiment of the present disclosure.

FIG. 2 is a schematic diagram illustrating an operation of an intrusion counteracting device for an in-vehicle network according to at least one exemplary embodiment of the present disclosure.

FIG. 3 is a schematic diagram of an intrusion counteracting device for an in-vehicle network according to at least one exemplary embodiment of the present disclosure.

FIGS. 4A and 4B are diagrams for explaining sequential booting and concurrent booting of ECUs according to at least one exemplary embodiment of the present disclosure.

FIG. 5 is a flowchart of an intrusion counteracting method for an in-vehicle network according to at least one exemplary embodiment of the present disclosure.

FIG. 6 is a flowchart of another intrusion counteracting method for an in-vehicle network according to at least one exemplary embodiment of the present disclosure.

### DETAILED DESCRIPTION

The present disclosure in some embodiments seeks to provide a method and a device for counteracting an intrusion into an in-vehicle network by operating, upon detecting the intrusion from an external network of a vehicle, to block a direct connection between the in-vehicle network and the external network and to establish an indirect connection between the in-vehicle network and the external network using a driver's terminal, thereby blocking a cyberattack and making use of the external network through the bypass path.

Other embodiments of the present disclosure seek to provide a method and a device for counteracting an intrusion into an in-vehicle network by operating, upon detecting the intrusion through an external network, to stop and restart the vehicle for activating the minimum required functions exclusively for driving, thereby preventing further cyber-attacks.

Yet other embodiments of the present disclosure seek to provide a method and a device for counteracting an intrusion into an in-vehicle network by operating, upon detecting the intrusion through an external network, to transmit intrusion detection information and vehicle state information through a drivers terminal to an external server and receive repair shop-related information through the driver's terminal, thereby prompting the driver to bring the vehicle into treatment.

Some exemplary embodiments of the present disclosure are described below with reference to the accompanying drawings. In the following description, like reference numerals preferably designate like elements, although the elements are shown in different drawings. Further, in the following description of some embodiments, a detailed description of known functions and configurations incorporated herein will be omitted for the purpose of clarity and for brevity.

Additionally, various terms such as first, second, A, B, (a), (b), etc., are used solely to differentiate one component from others but not to imply or suggest the substances, the order, or sequence of the components. Throughout this specification, when a part “includes” or “comprises” a component, the part is meant to further include other components, not excluding thereof unless there is a particular description contrary thereto. The terms such as “unit,” “module,” and the like refer to units for processing at least one function or operation, which may be implemented by hardware, software, or a combination thereof.

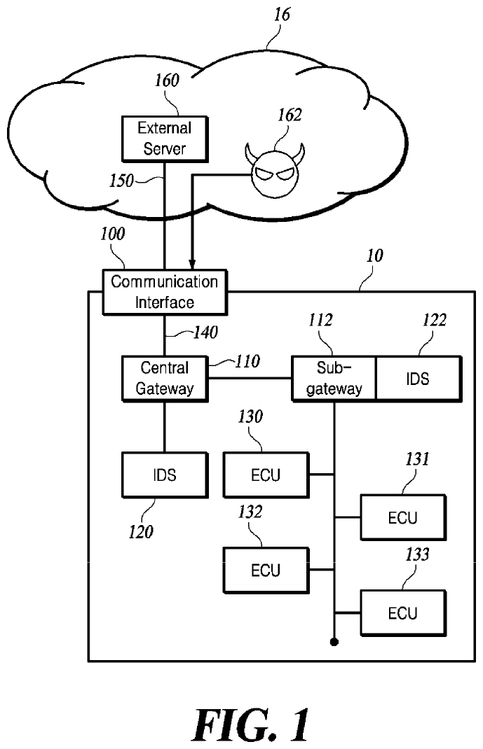

FIG. 1 is a schematic diagram illustrating a vehicle network system according to at least one exemplary embodiment of the present disclosure.

FIG. 1 illustrates a vehicle 10, a communication interface 100, at least one gateway 110, 112, at least one intrusion detection system (IDS) 120, 122, electronic control units (ECUs) 130, 131, 132, 133, communication paths 140, 150, an external network 16 that is outside of the vehicle 10, an external server 160, and an attacker 162.

The external network 16 is connected to the in-vehicle network through the communication interface 100 of the vehicle 10 and transmits information on the services that the vehicle 10 requires.

The external network 16 refers to a network that includes or links the external server 160, an operation center, roadside units, and the like. The external server 160 may provide various services to the vehicle 10. The external network 16 may also include the attacker 162. The attacker 162 attempts to break into the in-vehicle network through the communication paths 140, 150.

The external network 16 may communicate by methods based on a near field communication (NFC) scheme, Bluetooth Low Energy (BLE), wireless LAN (WIFI), ultra-wideband (UWB), radio frequency, Infrared Data Association (IrDA), Zigbee, Long Term Evolution (LTE), 5th-generation mobile networks (5G), 6G, Dedicated Short Range Communication (DSRC), Wireless Access for Vehicle Environment (WAVE), Vehicle-to-Everything (V2X), and C-V2X among others.

The in-vehicle network in the vehicle 10 includes at least one gateway 110, 112, at least one IDS 120, 122, ECUs 130, 131, 132, 133 and connects via the communication interface 100 to the external network 16.

The in-vehicle network may be composed of networks in various domains connected to the gateway 110/112. The in-vehicle network may be implemented as a Controller Area Network (CAN), Ethernet, Local Interconnect Network (LIN), FlexRay, or the like.

The in-vehicle network may further include a legacy CAN bus and an ETH-CAN gateway for some application programs for which Ethernet is not suitable. The legacy CAN bus may be connected to the central gateway 110 through the ETH-CAN gateway that supports communication between Ethernet and the CAN bus.

The communication interface 100 transmits or receives packets or messages between the external network 16 and the gateway 110/112 in the vehicle 10.

The communication interface 100 may refer to a vehicle-to-infrastructure (V21) modem for various purposes. For example, the communication interface 100 may be a wireless interface for providing route setting, user content, over-the-air update through an Intelligent Transport System (ITS), and the like.

The communication interface 100 may be implemented as a Transmission Controller (TCU) or a Communication Control Unit (CCU).

The gateway 110/112 serves as a gate between the external network 16 and the in-vehicle network. The gateway 110/112 performs communication with another device, server, system, etc. located remotely through the communication interface 100, and it may perform a conversion between a CAN message and an Ethernet frame in the process.

The gateway 110/112 may be a network point serving as an entrance to different networks, and it may serve as a passage between different types of networks. For example, the gateway 110/112 may provide a routing function between the ECUs 130, 131, 132, and 133 installed in the vehicle 10.

The gateway 110/112 may include a computer or software that enables the communication between different communication networks and between networks using different protocols in the in-vehicle network.

The gateway 110/112 includes a central gateway (CGW) 110 and a sub-gateway (SGW) 112.

The gateway 110/112 may be divided into the central gateway 110 and the sub-gateway 112. On the other hand, at least one of the gateways 110 and 112 may be composed of several equivalent gateways. Hereinafter, exemplary embodiments of the central gateway 110 and the sub-gateway 112 will be described.

The central gateway 110 serves as a router for transferring data between various domains of the in-vehicle network. Additionally, the central gateway 110 is a central communication node serving as a gate for communication between the external network 16 and the in-vehicle network. The central gateway 110 is a gate for all data coming into the vehicle 10.

The central gateway 110 performs access control by determining whether to allow an access request to the in-vehicle network. The central gateway 110 may connect or block communication between the external network 16 and the in-vehicle network.

The central gateway 110 is connected to the sub-gateway 112. Where a plurality of sub-gateways is provided, the central gateway 110 is connected to those sub-gateways.

The central gateway 110 may be connected to the ECUs 130, 131, 132, 133 through the sub-gateway 112, or it may be directly connected to the ECUs 130, 131, 132, 133.

The sub-gateway 112 is a local communication node responsible for a specific functional domain, such as a power train, chassis, body, infotainment, and the like. The sub-gateway 112 may be referred to as a domain gateway or a domain controller.

In FIG. 1, the sub-gateway 112 is represented as a single gateway, but it may be configured and represented as multiple sub-gateways.

A single sub-gateway is in charge of a single functional domain and is connected to ECUs of the corresponding functional domain. For example, a first sub-gateway may be connected to ECUs relevant to the powertrain domain, and a second sub-gateway may be connected to ECUs of the infotainment functional domain. Additionally, high-speed data application programs such as an Advanced Driver-Assistance System (ADAS) and multimedia may be connected to the sub-gateway 112 through an Ethernet-based LAN.

The IDS 120/122 utilizes a variety of detection algorithms for detecting an intrusion attempt to the in-vehicle network. The IDS 120/122 can monitor the network and detect an attempted attack and thereby enhance the security of the in-vehicle network.

Specifically, the IDS 120/122 may receive the operation state information of the vehicle 10 from the gateway 110/112 and the ECUs 130, 131, 132, 133, and may monitor all messages on the in-vehicle network. The IDS 120/122 may detect anomalies by analyzing characteristics such as a pattern or period of traffic transmitted from the in-vehicle network.

The IDS 120/122 analyzes the packet or message by using various detection methodologies. At least one of the IDSs 120 and 122 may selectively transmit detected attack information to other IDSs as needed to make more accurate decisions. Other IDSs may perform in-depth packet inspection, network forensics, determine the root cause of an attack, and build and deploy some countermeasures within the IDS.

In the in-vehicle network, the IDSs 120 and 122 may be installed inside the gateways 110 and 112, respectively. Alternatively, the IDS 120/122 may be connected as an independent entity to a bus and communicate with the gateway 110/112.

The ECUs 130, 131, 132, and 133 control the driving unit of the vehicle 10 and perform a drivers command in the in-vehicle network without being connected to the outside.

FIG. 1 illustrates four ECUs 130, 131, 132, 133, although they may be configured in various numbers. Additionally, the ECUs 130, 131, 132, 133 may be directly connected to the central gateway 110 or the sub-gateway 112.

ECUs 130, 131, 132, and 133 may comprise multiple ECUs being responsible for each of functional domains of the vehicle 10. Otherwise, the ECUs 130, 131, 132, and 133 may each be responsible for a single functional domain.

Here, the functional domains of the vehicle 10 may be classified into a powertrain domain, a chassis/safety domain, a body domain, a driver assistance system domain, and an infotainment domain. The infotainment domain includes a head unit and in-vehicle infotainment (IVI).

Transmission and exchange of information between ECUs 130, 131, 132, 133 may be made through a CAN controller. Besides being connected to the CAN bus, the ECUs 130, 131, 132, 133 may be connected to a bus using different communication protocols (e.g., LIN, FlexRay, Ethernet, etc.) in some functional domains.

ECUs 130, 131, 132, 133 are the target of cyberattacks. The ECUs 130, 131, 132, 133 may be installed with a software module having a function for counteracting an intrusion attack, that is, installed with a counteracting agent module.

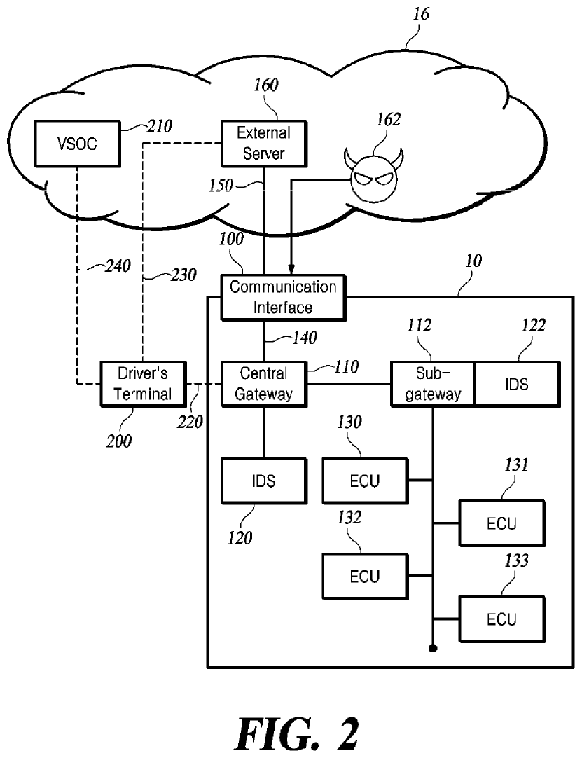

FIG. 2 is a schematic diagram illustrating an operation of an intrusion counteracting device for an in-vehicle network according to at least one exemplary embodiment of the present disclosure.

FIG. 2 shows the vehicle 10, the communication interface 100, at least one gateway 110, 112, at least one IDS 120, 122, ECUs 130, 131, 132, 133, communication paths 140, 150, external network 16, external server 160, attacker 162, a drivers terminal 200, vehicle security operation center (VSOC) 210, and alternative communication paths 220, 230, 240.

A device for counteracting an intrusion into an in-vehicle network of the vehicle 10 (hereinafter, referred to as an ‘intrusion counteracting device’) may be implemented on at least one of gateways 110 and 112. Preferably, the intrusion counteracting device is implemented on the central gateway 110. The intrusion counteracting device may be implemented as a separate device or may be mounted in the form of a software (SW) module in the central gateway 110 or the sub-gateway 112.

The intrusion counteracting device monitors intrusion attempts from the external network 16 into the in-vehicle network.

Specifically, the attacker 162 attempts to break into the in-vehicle network through the communication paths 140, 150, and the communication interface 100. At least one of the IDSs 120 and 122 detects the intrusion attempt by the attacker 162, and the intrusion counteracting device receives intrusion detection information from the IDS 120/122. The intrusion counteracting device identifies the intrusion attempt based on the received intrusion detection information.

Intrusion detection information means information about an intrusion attempt, such as identification information of the attacker 162, the attack time, attack type, and attack path thereof.

Upon detecting an intrusion into the in-vehicle network, the intrusion counteracting device blocks communication with the external network 16.

Specifically, the intrusion counteracting device blocks the communication paths 140, 150 by disabling or ending the function of the communication interface 100. The attacker 162 cannot intrude into the in-vehicle network through the communication paths 140 and 150.

The intrusion counteracting device attempts to access the external network 16 through the driver's terminal 200 in place of the communication interface 100. To this end, the intrusion counteracting device requests the drivers terminal 200 to establish a communication link.

To establish a communication link, the intrusion counteracting device notifies the driver's terminal 200 of an intrusion into the in-vehicle network by the attacker 162. The intrusion counteracting device requests the driver's terminal 200 to mediate communication with the external network 16.

When the driver permits communication mediation through the driver's terminal 200, the intrusion counteracting device may access the external network 16 through the drivers terminal 200. In other words, the driver's terminal 200 provides the alternative communication path 220, 230, 240 to the vehicle 10 in place of the communication paths 140, 150.

On the other hand, the driver's terminal 200 may include user equipment (UE), a mobile phone, a smartphone, a laptop computer, personal digital assistants (PDAs), a portable multimedia player (PMP), a slate PC, a tablet PC, an ultrabook, or a wearable device.

The intrusion counteracting device may communicate with the external network 16 through the driver's terminal 200. The intrusion counteracting device may communicate with the VSOC (vehicle security operation center) 210 and the external server 160 through the driver's terminal 200.

The VSOC 210 is an external server that manages the network security of the vehicle 10 and transmits counteracting information to the vehicle 10.

According to at least one exemplary embodiment of the present disclosure, the intrusion counteracting device transmits intrusion detection information and vehicle state information to the VSOC 210 through the driver's terminal 200. Here, the vehicle state information includes vehicle identification information, location, speed, driving information, state information of the gateway 110/112, and state information of the ECUs 130, 131, 132, and 133.

The VSOC 210 receives the in-vehicle network intrusion detection information and vehicle state information from the intrusion counteracting device through the driver's terminal 200. The VSOC 210 operates based on the intrusion detection information and vehicle state information received through the driver's terminal 200, to search the external network 16 for information about repair shops around the vehicle 10 or extract repair shop information from pre-stored information. The VSOC 210 transmits information about nearby repair shops through the driver's terminal 200 to the intrusion counteracting device.

The VSOC 210 transmits the vehicle state information or repair information relevant to the vehicle state information to a nearby repair shop of the vehicle 10 so that the vehicle 10 can be repaired promptly.

The intrusion counteracting device may receive information about the repair shops from the VSOC 210 and output the same information to the driver. The intrusion counteracting device may guide the driver to drive to the repair shop through voice or video.

According to at least one exemplary embodiment of the present disclosure, where the vehicle 10 is autonomous, the intrusion counteracting device may move the vehicle 10 by using the autonomous driving capability thereof to the repair shop.

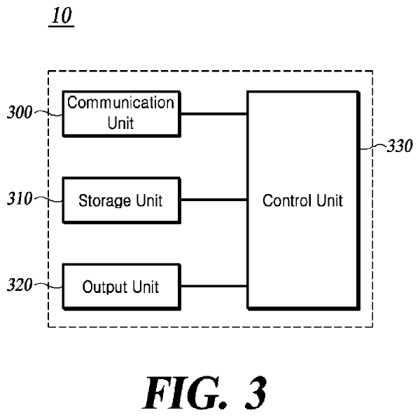

On the other hand, according to at least one exemplary embodiment of the present disclosure, the intrusion counteracting device may stop the vehicle 10 and reboot the vehicle 10 into a limp home mode (LHM) before putting the vehicle 10 in a repair shop. This will be described in detail referring to FIG. 3.

FIG. 3 is a schematic diagram of an intrusion counteracting device 30 for an in-vehicle network according to at least one exemplary embodiment of the present disclosure.

As shown in FIG. 3, the intrusion counteracting device 30 includes a communication unit 300, a storage unit 310, an output unit 320, and a control unit 330.

The communication unit 300 communicates with an external network outside of a vehicle and an in-vehicle network. Specifically, the communication unit 300 communicates with the external network through a communication interface. Additionally, the communication unit 300 communicates with at least one IDS and ECUs in the in-vehicle network. The communication unit 300 may be a hardware device implemented by various electronic circuits, e.g., processor, to transmit and receive signals via wireless or wired connections.

The communication unit 300 may include one or more components that enable communication and may use at least two communication schemes at the same time. The communication unit 300 supports both the communication scheme of the external network and the communication scheme of the in-vehicle network.

The storage unit 310 stores commands and information for counteracting an intrusion into the in-vehicle network. The storage unit 310 may be implemented as at least one non-transitory memory device.

The output unit 320 outputs, to the driver, information on countermeasure against an intrusion into the in-vehicle network. The output unit 320 according to one exemplary embodiment of the present disclosure may be any type of hardware devices that can output intrusion counteracting information to the driver through, for example, voice, image, vibration, or other prompting media. As an example, the output unit 320 may include at least one of a display, a lighting device, a speaker, a steering wheel or a seat implemented with a vibration unit having a motor, etc.

The control unit 330 performs overall control for countermeasure against an intrusion into the in-vehicle network. The control unit 330 may be implemented with at least one processor having an associated non-transitory memory storing software instructions which, when executed by the processor, provides the functions described herein.

The control unit 330 monitors an intrusion attempt to the in-vehicle network using the IDS and blocks communication with the external network upon detecting an intrusion attempt. The control unit 330 communicates with an external network of the vehicle through the driver's terminal as an alternative to the blocked communication path.

According to at least one exemplary embodiment of the present disclosure, the control unit 330 may stop the vehicle and rebooting the vehicle in a limp home mode (LHM) upon detecting an intrusion into the in-vehicle network.

Specifically, upon detecting an intrusion into the in-vehicle network, the control unit 330 causes the output unit 320 to guide the driver to stop the vehicle in a safe area. Here, the safe area means an area in which a vehicle can temporarily stop, such as a shoulder of a road, a parking lot, or a rest area.

According to at least one exemplary embodiment of the present disclosure, the control unit 330 may stop the vehicle by utilizing its autonomous driving function in a safe area.

When the vehicle is confirmed to be stopped, the control unit 330 changes the setting information of the ECUs to operate the vehicle exclusively by preset functions. The preset functions of the vehicle operate according to the setting information of the ECUs. The control unit 330 reboots the ECUs.

The preset functions of the vehicle mean functions operating in the limp home mode. The limp home mode refers to a driving mode in which only the requisite functions for driving are performed while excluding functions auxiliary to driving the vehicle. For example, in the limp home mode the vehicle does not perform functions such as an IDS function, an autonomous driving function, a convenience service, and a connectivity service. On the other hand, in the limp home mode the vehicle performs the requisite functions for the driver to drive the vehicle.

For rebooting the ECUs after the vehicle is stopped, the control unit 330 sets booting information for such first ECUs that are related to the preset functions among a plurality of ECUs and sets booting information for such second ECUs that not related to the preset functions.

Rebooting the ECUs is performed according to the booting information for the first ECUs and the booting information for the second ECUs. The booting information for the first ECUs may comprise information on sequential booting of application programs that are among application programs of each first ECU and related to the preset functions. Each first ECU has its full or partial function activated. On the other hand, the second ECUs are not activated.

The intrusion counteracting device 30 blocks the communication path intruded by the attacker and uses an alternative path through the driver's terminal so that the intrusion counteracting device 30 can communicate with the external network while maintaining the security of the in-vehicle network.

Furthermore, the intrusion counteracting device 30 may fundamentally block an additional attack by an attacker by restarting the vehicle in the limp home mode.

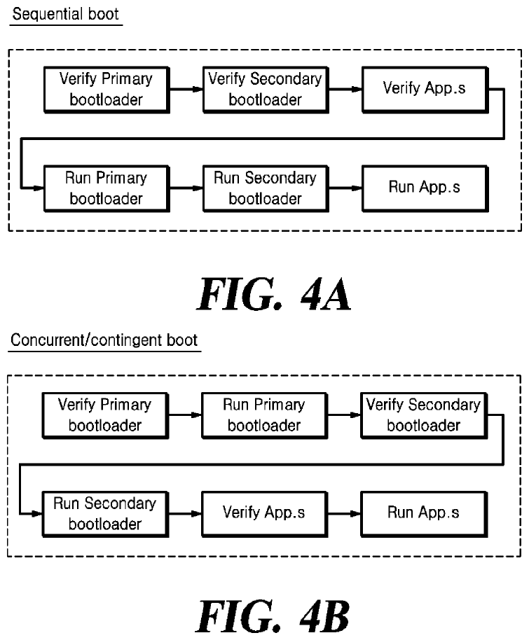

FIGS. 4A and 4B are diagrams for explaining sequential booting and concurrent booting of ECUs according to at least one exemplary embodiment of the present disclosure.

According to at least one exemplary embodiment of the present disclosure, application programs may be sequentially booted for ECUs respectively associated with functions operating in the limp home mode. Specifically, application programs may be executed by ECU. To execute the application programs of the ECUs, the verification operation and execution operation for the bootloader and the application are required.

As shown in FIG. 4A, to execute one application program, the steps initially performed are verification of bootloaders and verification of the application program. The subsequent step is to run the bootloaders. The final step is to run the application program of the ECU. This is called a sequential boot mode.

As shown in FIG. 4B, to execute one application program, the steps initially performed are to verify and run the first bootloader and to verify and run the second bootloader. The final steps are to verify and run the application program. This is called a concurrent boot mode or a continuous boot mode.

Each of the component ECUs operates to provide preset functions exclusively but no other functions.

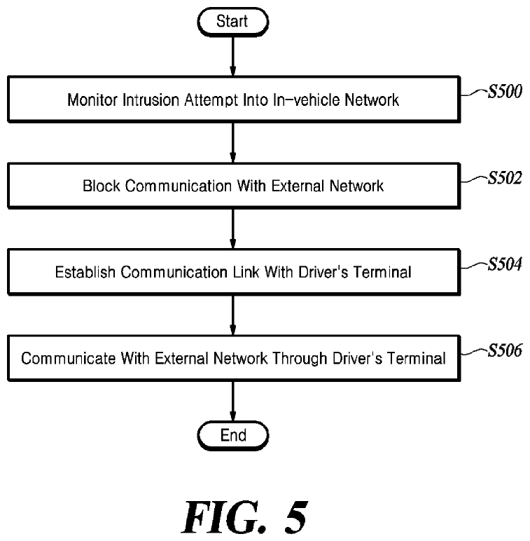

FIG. 5 is a flowchart of an intrusion counteracting method for an in-vehicle network according to at least one exemplary embodiment of the present disclosure.

As shown in FIG. 5, the intrusion counteracting device monitors an intrusion attempt into the in-vehicle network from the external network (S500).

Specifically, the IDS detects an attacker's intrusion attempt, and the intrusion counteracting device receives intrusion detection information from the IDS. The intrusion counteracting device identifies an intrusion attempt based on the received intrusion detection information.

The intrusion counteracting device blocks communication with the external network upon detecting an intrusion into the in-vehicle network (S502).

The intrusion counteracting device blocks the communication paths intruded by the attacker by disabling or stopping the function of the communication interface. This blocks the communication paths, making it impossible for the attacker to break into the in-vehicle network.

The intrusion counteracting device establishes a communication link with the driver's terminal (S504).

The intrusion counteracting device notifies the driver of an intrusion into the in-vehicle network. Then, the intrusion counteracting device requests the drivers terminal to mediate communication with the external network. When the driver sends the intrusion counteracting device a permission instruction to allow mediation through the drivers terminal, the intrusion counteracting device connects to the external network through the driver's terminal.

The intrusion counteracting device performs communication with the external network through the driver's terminal (S506).

The intrusion counteracting device may transmit the intrusion detection information and vehicle state information to an external server through the driver's terminal. The external server means a vehicle security operation center or VSOC for vehicle network security.

The VSOC may transmit information necessary for vehicle repair in advance to the intrusion counteracting device or a nearby repair shop. The intrusion counteracting device receives information about the surrounding repair shops from the VSOC. The intrusion counteracting device outputs the received information about the repair shops to the driver.

The intrusion counteracting device according to at least one exemplary embodiment guides the driver to stop the vehicle in a safe area or directly stops the vehicle in the safe area. Upon confirming the vehicle stoppage, the intrusion counteracting device reboots the ECUs in the vehicle so that the vehicle operates in the limp home mode. The intrusion counteracting device may restart the vehicle instead of rebooting the ECUs.

When the vehicle is in the limp home mode, ECUs that are related to functions operating in the limp home mode among the ECUs in the vehicle operate. ECUs that are not related to functions operating in limp home mode do not operate. Meanwhile, according to at least one exemplary embodiment, application programs that are related to functions operating in the limp home mode among the application programs of the ECUs may be booted sequentially. In other words, various functions of each of the ECUs are sequentially booted, and such functions that are not required in the limp home mode are not booted.

The intrusion counteracting device may communicate with the external network of the vehicle while maintaining network security by using an alternative communication path through the driver's terminal with the external network.

Additionally, the intrusion counteracting device can be safe from further cyberattacks by operating the vehicle in limp home mode.

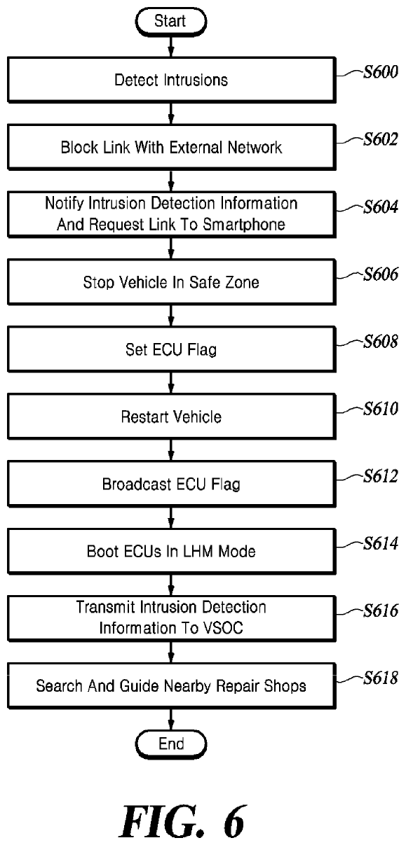

FIG. 6 is a flowchart of another intrusion counteracting method for an in-vehicle network according to at least one exemplary embodiment of the present disclosure.

As shown in FIG. 6, the intrusion counteracting device detects an attackers intrusion attempt into the in-vehicle network (S600).

Upon detecting an attacker's intrusion attempt, the intrusion counteracting device blocks the link with the external network (S602). The intrusion counteracting device blocks the communication path that the attacker attempted to intrude.

The intrusion counteracting device notifies the driver of intrusion detection information and requests a communication link to the drivers smartphone (S604). When the driver allows the communication link through the smartphone, the intrusion counteracting device connects through the smartphone to the external network.

The intrusion counteracting device guides the driver to stop the vehicle in a safety zone or directly stops the vehicle in the safety zone (S606).

The intrusion counteracting device sets the ECU flag for the limp home mode (S608). The ECU flag is an indication or instructions that preset functions be activated exclusively when the ECU is booted. ECUs that have received the ECU flag are booted with preset functions being activated exclusively. Here, the preset functions refer to the functions performed in the limp home mode.

The intrusion counteracting device restarts the vehicle (S610). The intrusion counteracting device may just reboot the ECUs instead of restarting the vehicle.

Right after restarting the vehicle, the intrusion counteracting device broadcasts the ECU flag to the ECUs (S612). The preset functions of ECUs are booted in response to the ECU flag.

The in-vehicle ECUs are booted to the limp home mode (S614). In the limp home mode, the intrusion counteracting device operates the ECUs that are related to functions needed for driving the vehicle, but it does not power the ECUs that are related to functions supplementary to the driving of the vehicle.

The intrusion counteracting device transmits intrusion detection information to the VSOC (S616). The intrusion counteracting device may transmit vehicle state information to the VSOC along with the intrusion detection information.

The VSOC searches for repair shops located in the vicinity of the vehicle based on the vehicle intrusion detection information and vehicle state information, and the intrusion counteracting device guides the driver with information about the repair shops (S618). To this end, the VSOC transmits information about the surrounding garages to the intrusion counteracting device.

The intrusion counteracting device provides the driver with information about the nearby repair shop to guide the vehicle to the repair shop. The vehicle can be repaired or have its security updated at the repair shop and reinstated to the condition before the attacker attempted to break-in.

Additionally, various terms such as first, second, A, B, (a), (b), etc., are used solely for the purpose of differentiating one component from others but not to imply or suggest the substances, the order, or sequence of the components. Throughout this specification, when a part “includes” or “comprises” a component, the part is meant to further include other components, not excluding thereof unless there is a particular description contrary thereto. The terms such as “unit,” “module,” and the like refer to units for processing at least one function or operation, which may be implemented by hardware, software, or a combination thereof.

The steps as illustrated in FIGS. 5 and 6 can be implemented as computer-readable codes on a computer-readable recording medium. The computer-readable recording medium includes any type of recording device on which data that can be read by a computer system are recordable. Examples of the computer-readable recording medium include a non-transitory medium such as a ROM, a RAM, a CD-ROM, a magnetic tape, a floppy disk, and an optical data storage. Further, the computer-readable recording medium can be distributed in computer systems connected via a network, wherein the computer-readable codes can be stored and executed in a distributed mode.

Further, the components of the present disclosure may use an integrated circuit structure such as a memory, a processor, a logic circuit, a look-up table, and the like. These integrated circuit structures perform the respective functions described herein through the control of one or more microprocessors or other control devices. Further, the components of the present disclosure include one or more executable instructions for performing a specific logical function, and they may be specifically implemented by a part of a program or codes executed by one or more microprocessors or other control devices. Further, the components of the present disclosure may include or be implemented by a central processing unit (CPU), a microprocessor, and the like that perform the respective functions. Besides, the components of the present disclosure may store instructions executed by one or more processors in one or more memories.

As described above, according to at least one exemplary embodiment of the present disclosure, the method and device for counteracting an intrusion into an in-vehicle network can operate, upon detecting the intrusion through an external network, to establish an indirect connection between the in-vehicle network and the external network using a driver's terminal, thereby blocking a cyberattack and making use of the external network through the bypass path.

According to other exemplary embodiments of the present disclosure, the method and device for counteracting an intrusion into an in-vehicle network can operate, upon detecting the intrusion through an external network, to stop and restart the vehicle for activating the minimum required functions exclusively for driving, thereby preventing further cyberattacks.

According to yet other exemplary embodiments of the present disclosure, the method and device for counteracting an intrusion into an in-vehicle network can operate, upon detecting the intrusion through an external network, to transmit intrusion detection information and vehicle state information through a driver's terminal to an external server and receive repair shop-related information through the driver's terminal, thereby prompting the driver to bring the vehicle into treatment.

Although exemplary embodiments of the present disclosure have been described for illustrative purposes, those skilled in the art will appreciate that various modifications, additions, and substitutions are possible, without departing from the idea and scope of the claimed invention. Therefore, exemplary embodiments of the present disclosure have been described for the sake of brevity and clarity. The scope of the technical idea of the present embodiments is not limited by the illustrations. Accordingly, one of ordinary skill would understand the scope of the claimed invention is not to be limited by the above explicitly described embodiments but by the claims and equivalents thereof.

What is claimed is:

1. A method performed by an onboard device in a vehicle for counteracting an intrusion into an in-vehicle network to protect the in-vehicle network, the method comprising:
monitoring an intrusion attempt from an external network into the in-vehicle network;
blocking a communication with the external network upon detecting the intrusion into the in-vehicle network;
establishing a communication link with a terminal of a driver of the vehicle; and
performing a communication with the external network through the terminal of the driver.

2. The method of claim 1, further comprising:
guiding the driver to stop the vehicle in a safe area; and
upon confirming that the vehicle is stopped, rebooting a plurality of electronic control units (ECUs) in the vehicle to operate the vehicle exclusively by preset functions.

3. The method of claim 1, further comprising:
stopping the vehicle in a safe area; and
rebooting a plurality of ECUs in the vehicle to operate the vehicle exclusively by preset functions.

4. The method of claim 2, wherein the preset functions comprise functions that operate in a limp-home mode.

5. The method of claim 2, wherein the rebooting a plurality of ECUs comprises:
setting booting information for first ECUs, among the plurality of ECUs, that are associated with the preset functions;
setting booting information for second ECUs, among the plurality of ECUs, that are unrelated to the preset functions; and
rebooting the plurality of ECUs according to the booting information set for the first ECUs and the booting information set for the second ECUs.

6. The method of claim 5, wherein the booting information set for the first ECUs comprises information on sequential booting of application programs, among application programs of each of the first ECUs, that are related to the preset functions.

7. The method of claim 1, wherein the establishing a communication link with a terminal of a driver comprises:
notifying the driver of the intrusion into the in-vehicle network; and
requesting the terminal of the driver to mediate a communication with the external network.

8. The method of claim 1, wherein the performing a communication with the external network comprises:
transmitting intrusion detection information and vehicle state information through the terminal of the driver to an external server.

9. The method of claim 1, wherein the performing a communication with the external network further comprises:
receiving information on a repair shop from an external server through the terminal of the driver; and
outputting the information on the repair shop to the driver.

10. A device for counteracting an intrusion into an in-vehicle network, the device comprising:
a communication unit configured to communicate with an external network and the in-vehicle network;
a memory in which instructions are stored; and
at least one processor,
wherein the instructions stored in the memory cause, when executed, the at least one processor to:
monitor an intrusion attempt from the external network into the in-vehicle network;
block a communication between the communication unit and the external network upon detecting the intrusion into the in-vehicle network;
establish a communication link with a terminal of a driver of the vehicle through the communication unit; and
perform a communication with the external network through the communication unit and the terminal of the driver.

11. The device of claim 10, further comprising:
an output unit,
wherein the instructions further cause, when executed, the at least one processor to:
guide the driver to stop the vehicle in a safe area through the output unit; and
upon confirming that the vehicle is stopped, reboot a plurality of electronic control units (ECUs) in the vehicle to operate the vehicle exclusively by preset functions.

12. The device of claim 10, wherein the instructions further cause, when executed, the at least one processor to:
stop the vehicle in a safe area; and
reboot a plurality of ECUs in the vehicle to operate the vehicle exclusively by preset functions.

13. The device of claim 11, wherein the preset functions comprise functions that operate in a limp-home mode.

14. The device of claim 11, wherein the instructions further cause, when executed, the at least one processor to:
set booting information for first ECUs, among the plurality of ECUs, that are associated with the preset functions;
set booting information for second ECUs, among the plurality of ECUs, that are unrelated to the preset functions; and
reboot the plurality of ECUs according to the booting information set for the first ECUs and the booting information set for the second ECUs.

15. The device of claim 14, wherein the booting information set for the first ECUs comprises information on sequential booting of application programs, among application programs of each of the first ECUs, that are related to the preset functions.

16. The device of claim 10, further comprising:
an output unit, and
wherein the instructions further cause, when executed, the at least one processor to:
notify the driver of the intrusion into the in-vehicle network through the output unit; and
request the terminal of the driver to mediate a communication with the external network.

17. The device of claim 10, wherein the instructions further cause, when executed, the at least one processor to:
transmit intrusion detection information and vehicle state information through the terminal of the driver to an external server.

18. The device of claim 10, further comprising:
an output unit, and
wherein the instructions cause, when executed, the at least one processor to:
receive information on a repair shop from an external server through the communication unit and the terminal of the driver; and
output the information on the repair shop to the driver through the output unit.
